(19) United States
(12) Patent Application Publication
(10) Pub. No.: US 2019/0077459 A1
(43) Pub. Date: Mar. 14, 2019

(54) VEHICLE CONTROL DEVICE, VEHICLE CONTROL METHOD, AND RECORDING MEDIUM

(71) Applicant: HONDA MOTOR CO., LTD., Tokyo (JP)

(72) Inventors: Hiroshi Miura, Wako-shi (JP); Makoto Ishikawa, Wako-shi (JP); Masamitsu Tsuchiya, Wako-shi (JP); Koji Kawabe, Wako-shi (JP)

(21) Appl. No.: 16/120,524

(22) Filed: Sep. 4, 2018

(30) Foreign Application Priority Data
Sep. 11, 2017 (JP) 2017-174228

(51) Int. Cl. B62D 15/02; B62D 6/02; B60W 30/12; B60W 10/20

(52) U.S. Cl. CPC B62D 15/0265; B62D 6/02; B60W 30/12; B60W 2710/20; B60W 2550/10; B60W 2550/14; B60W 10/20

(57) ABSTRACT

A vehicle control device including: an imager (10) imaging a side in front or side to the rear of a vehicle; a road partition line recognizer (131) recognizing a position of a road partition line on the basis of an image captured by the imager; and a driving controller (160) controlling at least steering of the vehicle on the basis of the position of the road partition line recognized by the road partition line recognizer, and, in a case in which a degree of recognition of the road partition line using the road partition line recognizer decreases due to presence of a vehicle running ahead or a vehicle running behind, the driving controller causes the vehicle to run while deviating from a center of a lane.

### CROSS-REFERENCE TO RELATED APPLICATION

Priority is claimed on Japanese Patent Application No. 2017-174228, filed on Sep. 11, 2017, the content of which is incorporated herein by reference.

### BACKGROUND OF THE INVENTION

### Field of the Invention

The present invention relates to a vehicle control device, a vehicle control method, and a storage medium.

### Description of Related Art

For example, in a case in which a bus or a large truck is traveling in front of a subject vehicle, there is a problem that a driver's field of view may be blocked by the vehicle traveling ahead, and a traffic signal in front thereof may not be visible. Regarding this problem, there is a technology in which cameras are mounted in side mirrors, traffic signals are imaged using the cameras, and the captured images are provided for a driver (for example, see Japanese Unexamined Patent Application, First Publication No. 2008-056052).

### SUMMARY OF THE INVENTION

However, a case in which it is difficult to recognize road partition lines due to cars traveling ahead has not been reviewed.

An aspect of the present invention is in view of such situations, and one object thereof is to provide a vehicle control device, a vehicle control method, and a storage medium capable of recognizing road partition lines even in a case in which it is difficult to recognize the road partition lines due to cars running ahead and the like.

A vehicle control device, a vehicle control method, and a storage medium according to the present invention employ the following configurations.

(1) According to one aspect of the present invention, there is provided a vehicle control device including: an imager imaging a side in front or side to the rear of a vehicle; a road partition line recognizer recognizing a position of a road partition line on the basis of an image captured by the imager; and a driving controller controlling at least steering of the vehicle on the basis of the position of the road partition line recognized by the road partition line recognizer, in which, in a case in which a degree of recognition of the road partition line using the road partition line recognizer decreases due to presence of a vehicle running ahead or a vehicle running behind, the driving controller causes the vehicle to run while deviating from a center of a lane.

(2) In the aspect (1) described above, a speed acquirer acquiring a speed of another vehicle running in an adjacent lane is further included, and the driving controller determines a side to which the vehicle deviates in running from the center of the lane on the basis of the speed of the another vehicle acquired by the speed acquirer.

(3) In the aspect (2) described above, the driving controller causes the vehicle to run while deviating from the center of the lane such that the vehicle is close to a side of an adjacent lane in which the speed of the another vehicle acquired by the speed acquirer is close to the speed of the vehicle.

(4) In the aspect (1) described above, the driving controller causes the vehicle to run while deviating from the center of the lane for a predetermined time and then run along the center of the lane.

(5) In the aspect (1) described above, in a case in which a vehicle running ahead or a vehicle running behind runs while deviating to one side from the center of the lane, the driving controller causes the vehicle to run while deviating from the center of the lane on a side opposite to a side on which the vehicle running ahead or the vehicle running behind deviates from the center of the lane.

(6) In the aspect (1) described above, in a case in which there is a curve in an advancement direction of the vehicle, the driving controller causes the vehicle to run while deviating from the center of the lane.

(7) According to one aspect of the present invention, there is provided a vehicle control method using an in-vehicle computer, including: imaging a side in front or side to the rear of a vehicle using an imager; recognizing a position of a road partition line on the basis of an image captured by the imager using a road partition line recognizer; controlling at least steering of the vehicle on the basis of the position of the road partition line recognized by the road partition line recognizer using a driving controller; and causing the vehicle to run while deviating from center of the lane using the driving controller in a case in which a degree of recognition of the road partition line using the road partition line recognizer decreases due to presence of a vehicle running ahead or a vehicle running behind.

(8) According to one aspect of the present invention, there is provided a storage medium storing thereon a non-transitory computer-readable program for causing a computer mounted in a vehicle including an imager imaging a side in front or side to the rear of the vehicle to execute: a process of recognizing a position of a road partition line on the basis of an image captured by the imager; a process of controlling at least steering of the vehicle on the basis of the recognized position of the road partition line; and a process of causing the vehicle to run while deviating from a center of a lane in a case in which a degree of recognition of the road partition line decreases due to presence of a vehicle running ahead or a vehicle running behind.

According to aspects (1) to (8) described above, even in a case in which it is difficult to recognize road partition lines due to cars running ahead and the like, the road partition lines can be recognized.

### BRIEF DESCRIPTION OF THE DRAWINGS

FIG. 1 is a configuration diagram of a vehicle system that uses a vehicle control device according to an embodiment;

FIG. 2 is a functional configuration diagram of a first controller and a second controller;

FIG. 3 is a diagram illustrating a view in which a target locus is generated on the basis of a recommended lane;

FIG. 4 is a flowchart illustrating one example of a process using an offset controller;

FIG. 5 is a flowchart illustrating another example of a process using an offset controller;

FIG. 6 is a flowchart illustrating one example of a process using an offset direction determiner;

FIG. 7 is a flowchart illustrating another example of a process using an offset direction determiner;

FIG. 8 is a flowchart illustrating another example of a process using an offset direction determiner;

FIG. 9 is a diagram illustrating movement of a subject vehicle M of a case in which an offset direction is determined;

FIG. 10 is a diagram illustrating movement of a subject vehicle M of a case in which an offset direction is determined;

FIG. 11 is a diagram illustrating movement of a subject vehicle M of a case in which an offset direction is determined;

FIG. 12 is a diagram illustrating movement of a subject vehicle M of a case in which an offset direction is determined;

FIG. 13 is a diagram illustrating movement of a subject vehicle M of a case in which an offset direction is determined;

FIG. 14 is a diagram illustrating movement of a subject vehicle M of a case in which an offset direction is determined;

FIG. 15 is a configuration diagram of a vehicle system using a vehicle control device according to an embodiment; and

FIG. 16 is a diagram illustrating one example of the hardware configuration of a vehicle control device according to an embodiment.

### DETAILED DESCRIPTION OF THE INVENTION

### First Embodiment

Hereinafter, a vehicle control device, a vehicle control method, and a storage medium according to embodiments of the present invention will be described with reference to the drawings. Hereinafter, although a case in which a rule of keeping to the left is applied will be described, the left side and the right side may be read by being interchanged in a case in which a rule of keeping to the right is applied.

### [Entire Configuration]

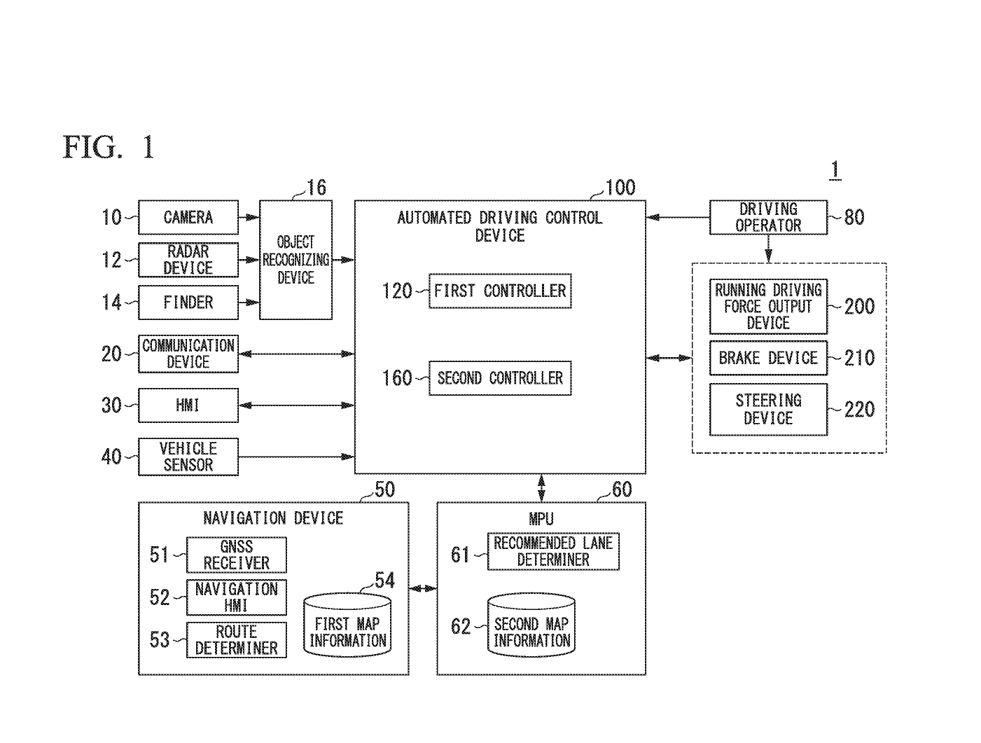

FIG. 1 is a configuration diagram of a vehicle system 1 using a vehicle control device according to an embodiment. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. In a case in which an electric motor is included, the electric motor operates using power generated using a power generator connected to an internal combustion engine or discharge power of a secondary cell or a fuel cell.

The vehicle system 1, for example, includes a camera 10, a radar device 12, a finder 14, an object recognizing device 16, a communication device 20, a human machine interface (HMI) 30, a vehicle sensor 40, a navigation device 50, a map positioning unit (MPU) 60, a driving operator 80, an automatic driving control device 100, a running driving force output device 200, a brake device 210, and a steering device 220. Such devices and units are interconnected using a multiplex communication line such as a controller area network (CAN) communication line, a serial communication line, a radio communication network, or the like. The configuration illustrated in FIG. 1 is merely one example, and thus, a part of the configuration may be omitted, and, furthermore, other components may be added thereto.

The camera 10, for example, is a digital camera using a solid-state imaging device such as a charge coupled device (CCD) or a complementary metal oxide semiconductor (CMOS). One or a plurality of cameras 10 are installed at arbitrary places on a vehicle (hereinafter, referred to as a subject vehicle M) in which the vehicle system 1 is mounted. In a case in which the side in front is to be imaged, the camera 10 is installed at an upper part of a front windshield, a rear face of a rear-view mirror, or the like. The camera 10, for example, repeatedly images the vicinity of the subject vehicle M periodically. The camera 10 may be a stereo camera.

The radar device 12 emits radiowaves such as millimeter waves to the vicinity of the subject vehicle M. The radar device 12 detects at least a position (a distance and an azimuth) of an object by detecting radiowaves (reflected waves) reflected by the object. One or a plurality of radar devices 12 are installed at arbitrary places on the subject vehicle M. The radar device 12 may detect a position and a speed of an object using a frequency modulated continuous wave (FM-CW) system.

The finder 14 is a light detection and ranging (LIDAR) device. The finder 14 emits light to the vicinity of the subject vehicle M and measures scattered light. The finder 14 detects a distance to a target on the basis of a time from light emission to light reception. The emitted light emitted using the finder 14, for example, is laser light having a pulse form. One or a plurality of finders 14 are installed at arbitrary places on the subject vehicle M.

The object recognizing device 16 may perform a sensor fusion process on results of detection using some or all of the camera 10, the radar device 12, and the finder 14, thereby allowing recognition of a position, a type, a speed, and the like of an object. The object recognizing device 16 outputs a result of recognition to the automatic driving control device 100. In addition, the object recognizing device 16, as is necessary, may output results of detection using the camera 10, the radar device 12, and the finder 14 to the automatic driving control device 100 as they are. The object recognizing device 16 is one example of a speed acquirer that acquires speeds of other vehicles running in adjacent lanes. The speed acquirer may include the radar device 12 in addition to the object recognizing device 16.

The communication device 20, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 presents various types of information to an occupant of the subject vehicle M. The HMI 30 receives an input operation performed by a vehicle occupant. The HMI 30 may include various display devices, a speaker, a buzzer, a touch panel, switches, keys, and the like.

The vehicle sensor 40 includes a vehicle speed sensor that detects a speed of the subject vehicle M, an acceleration sensor that detects an acceleration, a yaw rate sensor that detects an angular velocity around a vertical axis, an azimuth sensor that detects the azimuth of the subject vehicle M, and the like.

The navigation device 50, for example, includes a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of a subject vehicle M on the basis of signals received from GNSS satellites. The position of the subject vehicle M may be identified or complemented by an inertial navigation system (INS) using an output of the vehicle sensor 40. The navigation HMI 52 includes a display device, a speaker, a touch panel, a key, and the like. A part or the whole of the navigation HMI 52 and the HMI 30 described above may be configured to be shared. The route determiner 53, for example, determines a route from a location of the subject vehicle M identified by the GNSS receiver 51 (or an input arbitrary location) to a destination input by a vehicle occupant using the navigation HMI 52 (hereinafter, referred to as a route on a map) by referring to the first map information 54. The first map information 54, for example, is information in which a road form is represented by respective links representing a road and respective nodes connected using the links. The first map information 54 may include a curvature of each road, point of interest (POI) information, and the like. The route on the map determined by the route determiner 53 is output to the MPU 60. In addition, the navigation device 50 may perform route guidance using the navigation HMI 52 on the basis of the route on the map determined by the route determiner 53. The navigation device 50, for example, may be realized by a function of a terminal device such as a smartphone or a tablet terminal held by a vehicle occupant. In addition, the navigation device 50 may transmit a current location and a destination to a navigation server through the communication device 20 and acquire a route on the map received from the navigation server as a reply.

The MPU 60, for example, functions as a recommended lane determiner 61 and maintains second map information 62 in a storage device such as a HDD or a flash memory. The recommended lane determiner 61 divides a route provided from the navigation device 50 into a plurality of blocks (for example, divides the route into blocks of 100 [m] in the advancement direction of the vehicle). The recommended lane determiner 61 determines a recommended lane for each block by referring to the second map information 62. The recommended lane determiner 61 determines running on a specific lane from the left side. In a case in which a branching place, a merging place, or the like is present in the route, the recommended lane determiner 61 determines a recommended lane such that the subject vehicle M can run on a reasonable route for advancement to divergent destinations.

The second map information 62 is map information having an accuracy higher than that of the first map information 54. The second map information 62, for example, includes information of the center of respective lanes, information on boundaries between lanes, or the like. In addition, in the second map information 62, road information, traffic regulations information, address information (address and zip code), facilities information, telephone information, and the like may be included. By accessing another device using the communication device 20, the second map information 62 may be updated as needed.

The driving operator 80, for example, includes an acceleration pedal, a brake pedal, a shift lever, a steering wheel, a steering wheel variant, a joystick, and other operators. A sensor detecting the amount of an operation or the presence/absence of an operation is installed in the driving operator 80, and a result of the detection is output to at least one or all of the automatic driving control device 100, the running driving force output device 200, the brake device 210, and the steering device 220.

The automatic driving control device 100, for example, includes a first controller 120, and a second controller 160. Each of the first controller 120 and second controller 160, for example, is realized by a hardware processor such as a central processing unit (CPU) executing a program (software). In addition, some or all of such constituent elements may be realized by hardware (a circuit unit; including circuitry) such as a large scale integration (LSI), an application specific integrated circuit (ASIC), a field-programmable gate array (FPGA), or a graphics processing unit (GPU) or may be realized by cooperation between software and hardware. A program may be stored in a storage device such as a hard disk drive (HDD) or a flash memory in advance or may be stored in a storage medium such as a DVD or a CD-ROM that can be loaded or unloaded and be installed in a storage device by loading the storage medium into a drive device.

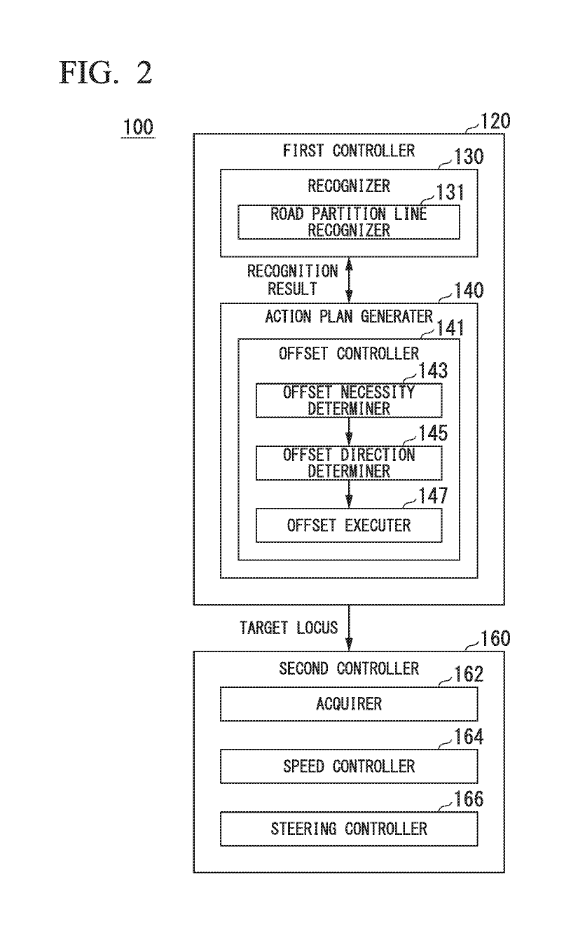

FIG. 2 is a functional configuration diagram of the first controller 120 and the second controller 160. The first controller 120, for example, includes a recognizer 130 and an action plan generator 140. The first controller 120, for example, simultaneously realizes functions using artificial intelligence (AI) and functions using a model provided in advance. For example, a function of “recognizing an intersection” may be realized by executing recognition of an intersection using deep learning or the like and recognition based on conditions given in advance (a signal, road markings, and the like that can be used for pattern matching are present) at the same time and comprehensively evaluating by scoring both thereof on the basis of a result of the execution. Accordingly, the reliability of automatic driving is secured.

The action plan generator 140 includes an offset controller 141. The offset controller 141 includes an offset necessity determiner 143, an offset direction determiner 145, and an offset executer 147. The functions of these will be described later, and, first, basic functions of the recognizer 130 and the action plan generator 140 will be described.

The recognizer 130 recognizes states such as a position, a speed, an acceleration, and the like of each object present in the vicinity of the subject vehicle M on the basis of information input from the camera 10, the radar device 12, and the finder 14 through the object recognizing device 16. The position of an object, for example, is recognized as a position on an absolute coordinate system having a representative point (the center of gravity, the center of a driving shaft, or the like) of the subject vehicle M as its origin and is used for a control process. The position of an object may be represented as a representative point such as the center of gravity or a corner of an object or may be represented as a representative area. A “state” of an object may include an acceleration or a jerk or an “action state” (for example, the object is changing lane or is to change lane) of an object. In addition, the recognizer 130 recognizes the shape of a curve through which the subject vehicle M will pass subsequently on the basis of a captured image captured by the camera 10. The recognizer 130 converts the shape of the curve in the captured image captured by the camera 10 into one on an actual plane and, for example, outputs point sequence information or information expressed using a model equivalent thereto to the action plan generator 140 as information representing the shape of the curve.

The recognizer 130, for example, recognizes a lane (running lane) in which the subject vehicle M runs. A result of the recognition of a lane, for example, indicates a line in which the subject vehicle M runs among a plurality of lanes having the same advancement direction. In the case of one line, an indication of one lane may be a result of the recognition. For example, the recognizer 130 compares a pattern of road partition lines acquired from the second map information 62 (for example, an array of solid lines and broken lines) with a pattern of road partition lines in the vicinity of the subject vehicle M that has been recognized from an image captured by the camera 10, thereby recognizing a running lane. The recognizer 130 is not limited to recognizing road partition lines and may recognize a running lane by recognizing running lane boundaries (road boundaries) including a road partition line, a road shoulder, curbstones, a median strip, a guardrail, and the like. In the recognition, the position of the subject vehicle M acquired from the navigation device 50 or a result of the process executed by an INS may be additionally taken into account. In addition, the recognizer 130 may recognize a temporary stop line, an obstacle object, a red light, a tollgate, and other road events.

When a running lane is recognized, the recognizer 130 recognizes a position and a posture of the subject vehicle M with respect to the running lane. The recognizer 130, for example, may recognize the a deviation quantity of a reference point on the subject vehicle M from the center of the lane and an angle of the subject vehicle M with respect to a line extending along the center of the lane in the advancement direction as a relative position and a posture of the subject vehicle M with respect to the running lane. Instead of this, the recognizer 130 may recognize a position of a reference point on the subject vehicle M with respect to one of side end parts (a road partition line or a road boundary) of the running lane or the like as a relative position of the subject vehicle M with respect to the running lane.

The recognizer 130 includes a road partition line recognizer 131. The road partition line recognizer 131 recognizes positions of road partition lines in the vicinity of the subject vehicle M on the basis of images captured by the camera 10. The road partition line recognizer 131 derives the degree of recognition of a road partition line on the basis of a result of the recognition and outputs the degree of recognition to the offset controller 141. The degree of recognition of a road partition line, for example, is a length of a recognized road partition line, an area proportion for an image road partition line detected from a captured image captured by the camera 10, and the like.

In the recognition process described above, the recognizer 130 may derive a recognition accuracy and output the derived recognition accuracy to the action plan generator 140 as recognition accuracy information. For example, the recognizer 130 may generate recognition accuracy information on the basis of a frequency at which a road partition line is recognized over a predetermined time period.

The action plan generator 140 determines events to be sequentially executed in automatic driving such that the subject vehicle basically runs on a recommended lane determined by the recommended lane determiner 61 and can respond to a surroundings status of the subject vehicle M. As the events, for example, there are a constant-speed running event for running at a constant speed in the same running lane, a following running event of following a vehicle running ahead, an overtaking event of overtaking a vehicle running ahead, an avoidance event of performing braking and/or steering for avoiding approaching an obstacle object, a curved running event of running on a curve, a passing through event for passing through a predetermined point such as an intersection, a pedestrian crossing, a railroad crossing, or the like, a lane change event, a merging event, a branching event, an automatic stopping event, a takeover event for ending automatic driving and switching to manual driving, and the like.

The action plan generator 140 generates a target locus along which the subject vehicle M will run in the future in accordance with operating events. Details of each functional unit will be described later. The target locus, for example, includes a speed element. For example, the target locus is represented by sequentially aligning places (locus points) at which the subject vehicle M is to arrive. A locus point is a place at which the subject vehicle M will arrive at respective predetermined running distances (for example, about every several [m]) in length or distance, and separately, a target speed and a target acceleration for each of predetermined sampling times (for example, a fraction of a [sec]) are generated as a part of the target locus. A locus point may be a position at which the subject vehicle M will arrive at a sampling time for each predetermined sampling time. In such a case, information of a target speed or a target acceleration is represented using intervals between the locus points.

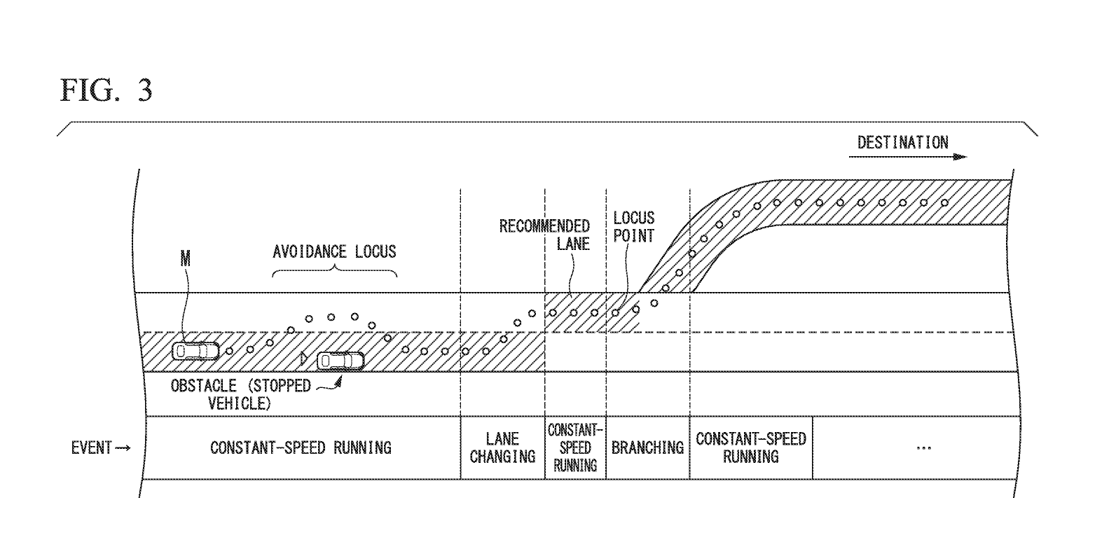

FIG. 3 is a diagram illustrating a view in which a target locus is generated on the basis of recommended lanes. As illustrated in the drawing, the recommended lanes are set such that surroundings are good for running along a route to a destination. When reaching a predetermined distance before a place at which a recommended lane is changed (may be determined in accordance with a type of event), the action plan generator 140 executes the passing through event, the lane change event, the branching event, the merging event, or the like. During execution of each event, in a case in which there is a need to avoid an obstacle object, an avoidance locus is generated as illustrated in the drawing.

The second controller 160 performs control of the running driving force output device 200, the brake device 210, and the steering device 220 such that the subject vehicle M passes along a target locus generated by the action plan generator 140 at a scheduled time.

Referring back to FIG. 2, the second controller 160, for example, includes an acquirer 162, a speed controller 164, and a steering controller 166. The acquirer 162 acquires information of a target locus (locus point) generated by the action plan generator 140 and stores the target locus in a memory (not illustrated). The speed controller 164 controls the running driving force output device 200 or the brake device 210 on the basis of a speed element accompanying the target locus stored in the memory. The steering controller 166 controls the steering device 220 in accordance with a degree of curvature of the target locus stored in the memory. The processes of the speed controller 164 and the steering controller 166, for example, are realized by a combination of feed forward control and feedback control. For example, the steering controller 166 may execute feed forward control according to the curvature of a road in front of the subject vehicle M and feedback control based on a deviation from the target locus in combination.

The running driving force output device 200 outputs a running driving force (torque) used for a vehicle to run to driving wheels. The running driving force output device 200, for example, includes a combination of an internal combustion engine, an electric motor, a transmission, and the like and an ECU controlling these components. The ECU controls the components described above in accordance with information input from the second controller 160 or information input from the driving operator 80.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the second controller 160 or information input from the driving operator 80 such that a brake torque according to a brake operation is output to each vehicle wheel. The brake device 210 may include a mechanism delivering hydraulic pressure generated in accordance with an operation on the brake pedal included in the driving operators 80 to the cylinder through a master cylinder as a backup. The brake device 210 is not limited to the configuration described above and may be an electronically-controlled hydraulic brake device that delivers hydraulic pressure in the master cylinder to a cylinder by controlling an actuator in accordance with information input from the second controller 160.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the second controller 160 or information input from the driving operator 80.

Next, the offset controller 141 included in the action plan generator 140 will be described in detail. The offset controller 141 executes control of shifting a position at which the subject vehicle M runs within its own lane in the vehicle width direction (hereinafter, referred to as offset control) in accordance with a result state of the recognition process using the recognizer 130. The offset control, for example, is control of causing the subject vehicle M to run while deviating from the center of its own lane. In the offset control, the amount by shift the subject vehicle M is shifted, for example, is represented as a distance from the center of its own lane. Hereinafter, the amount of shift will be denoted as an offset quantity Yo. The offset quantity Yo may be determined in advance in accordance with an installation position of the camera 10 or the like and may be dynamically changed in accordance with a surrounding status. In the offset control, a direction (the left side or the right side) in which the subject vehicle M is to be shifted will be denoted as an offset direction Do. The offset direction Do is determined by the offset direction determiner 145. In the offset control, control of causing the subject vehicle M to run at a shifted position continuously for a predetermined time is also included. The time in which the subject vehicle is caused to continuously run will be denoted as an offset time To. The offset time To may be determined in accordance with the speed of the subject vehicle M and the degree of recognition of road partition lines derived by the road partition line recognizer 131. The function of each component included in the offset controller 141 will be described with reference to flowcharts to be described below.

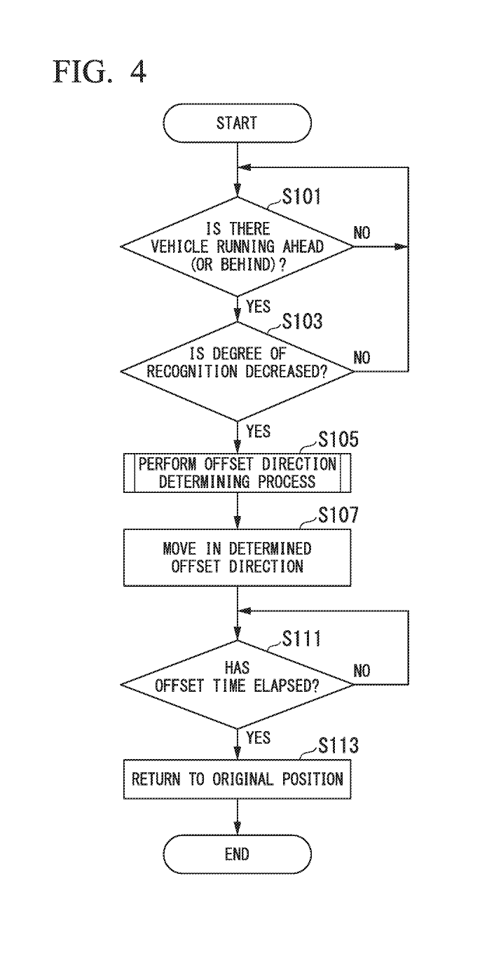

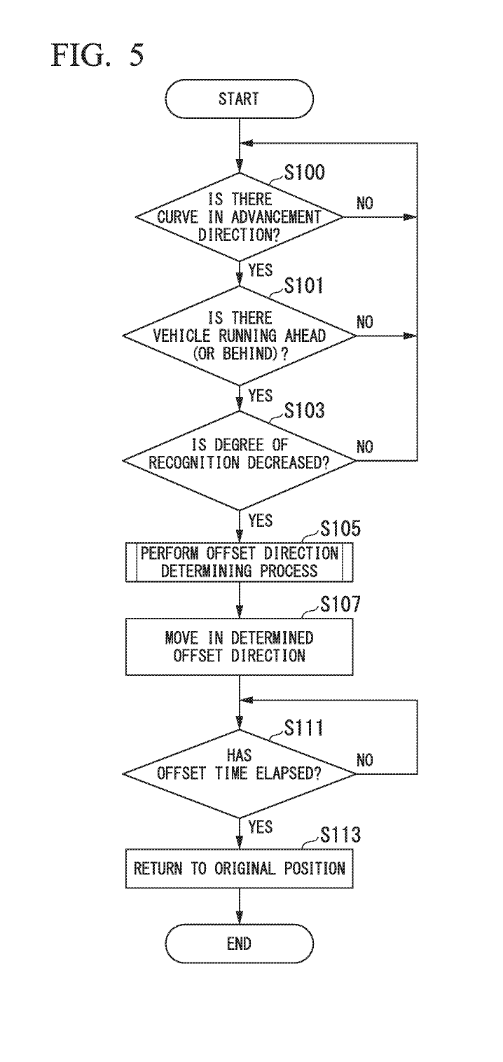

Next, one example of the process using the offset controller 141 will be described with reference to FIGS. 4 and 5. FIGS. 4 and 5 are flowcharts illustrating one example of the process using the offset controller 141.

First, the offset necessity determiner 143 determines whether or not a distance between a vehicle running ahead that is recognized by the recognizer 130 and the subject vehicle M (or a distance between a vehicle running behind and the subject vehicle M) is equal to or less than a threshold (Step S101). In a case in which the distance between a vehicle running ahead and the subject vehicle M (or the distance between a vehicle running behind and the subject vehicle M) is equal to or less than the threshold, the offset necessity determiner 143 determines whether or not the degree of recognition of road partition lines input from the road partition line recognizer 131 is equal to or less than a threshold (Step S103). In a case in which the degree of recognition of road partition lines is equal to or less than the threshold, the offset necessity determiner 143 determines that offset control is necessary. In such a case, the offset direction determiner 145 executes a process of determining an offset direction Do (Step S105). This process will be described later. In a case in which “No” is determined in any one of Steps S101 and S103, the offset controller 141 causes the process to be returned to Step S101.

Next, the offset executer 147 generates a target locus for causing the subject vehicle M to be shifted from the center of its own lane by the offset quantity Yo in the offset direction Do determined by the offset direction determiner 145 and then, to continuously run at a shifted position and outputs the generated target locus to the second controller 160 (Step S107). Accordingly, the subject vehicle M runs in the state of being moved in the determined offset direction Do. Then, the offset executer 147 determines whether or not an offset time To has elapsed from a time point at which the subject vehicle M moved in the offset direction Do (Step S111). In a case in which the offset time To has elapsed from the time point at which the subject vehicle M moved in the offset direction Do, the offset executer 147 generates a target locus causing the subject vehicle M to run at the original position (for example, the center of a lane) and outputs the generated target locus to the second controller 160 (Step S113).

In accordance with such a process, the subject vehicle M can be caused to run for a predetermined time at a position at which the camera 10 can easily image road partition lines, and accordingly, the road partition lines can be recognized.

Conditions for the execution of the offset control are not limited to the description presented above. For example, as illustrated in FIG. 5, the offset necessity determiner 143 may additionally determine whether or not a curve shape is recognized in the advancement direction on the basis of a result of the recognition acquired by the recognizer 130. In the process illustrated in FIG. 5, the offset necessity determiner 143 determines whether or not there is a curve in the advancement direction of the subject vehicle M (Step S100). In a case in which there is a curve in the advancement direction of the subject vehicle M, the process of Step S101 and subsequent steps is executed. On the other hand, in a case in which there is no curve in the advancement direction of the subject vehicle M, the process of Step S101 and subsequent steps is not executed. In such a case, in a case in which a curve shape is recognized in the advancement direction and in a case predetermined conditions are satisfied, the offset controller 141 can execute the offset control. The offset necessity determiner 143, instead of the flow of the process illustrated in FIG. 5, may execute determination A and/or execute determination B. The determination A is another example of Step S101 and, for example, is determination corresponding to Step S101 in which, in a case in which a curve shape is recognized in the advancement direction of the subject vehicle M, a threshold of a distance used for a comparison in Step S101 is set to be larger than that of a case in which no curve shape is recognized. The determination B is another example of Step S103 and, for example, is determination corresponding to Step S103 in which a threshold of the degree of recognition used for a comparison in S103 is set to be high. In such a case, in a case in which a curve shape is recognized in the advancement direction of the subject vehicle M, the offset control is set as being more easily executed than in a case in which no curve shape is recognized. In a case in which the subject vehicle M passes through the curve shape, the offset executer 147 may perform control of returning the subject vehicle to the original position.

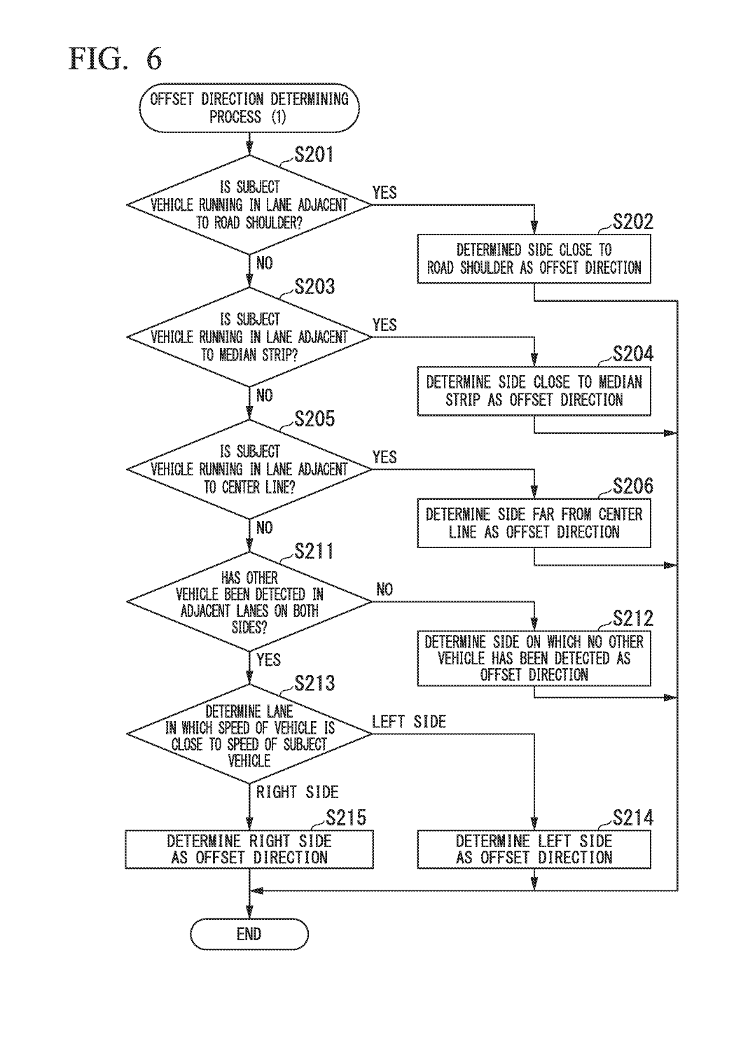

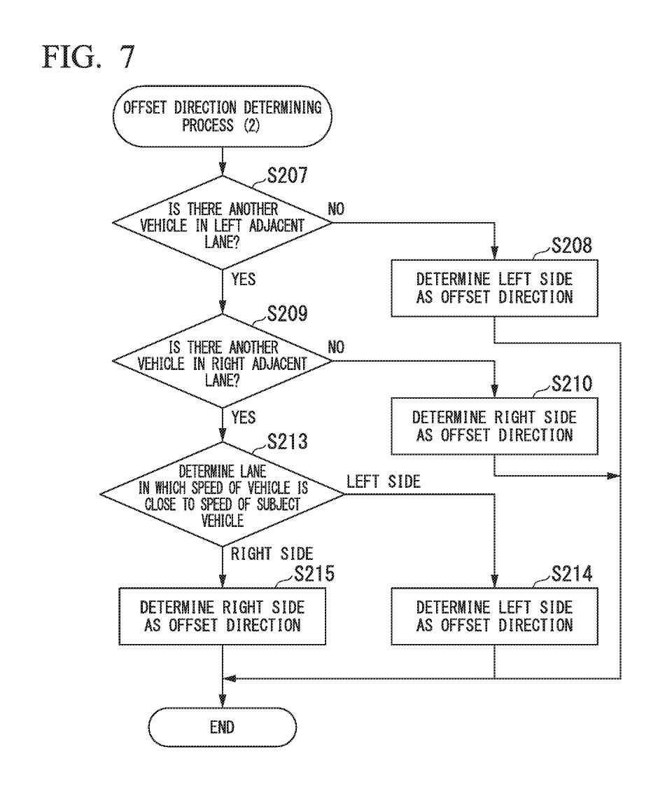

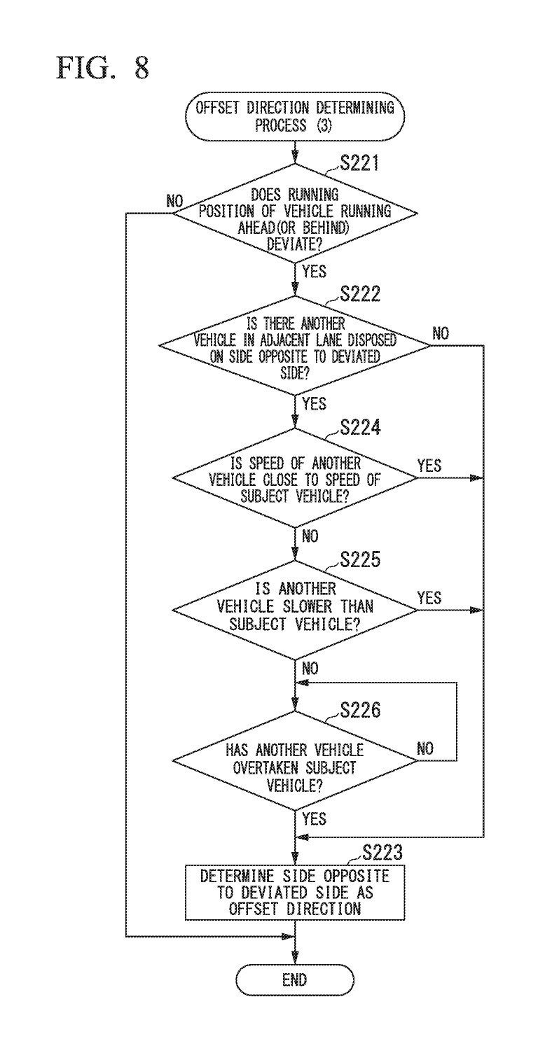

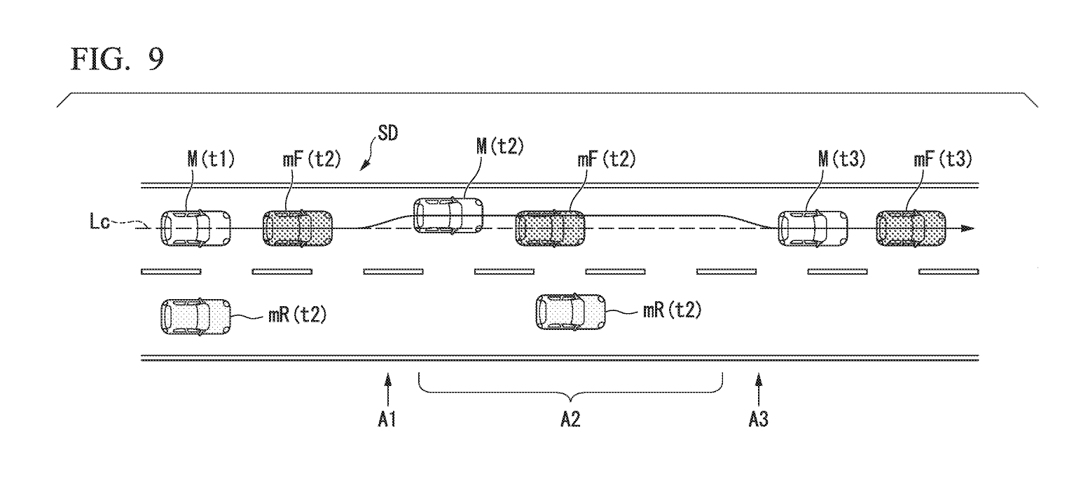

Next, one example of the process performed using the offset direction determiner 145 will be described with reference to FIGS. 6 to 8. FIGS. 6 to 8 are flowcharts illustrating one example of the process performed using the offset direction determiner 145. In the following process, the movement of the subject vehicle M of a case in which the offset direction Do is determined will also be appropriately described with reference to FIGS. 9 to 14.

### [Offset Direction Determining Process (1)]

First, the offset direction determiner 145 determines whether or not its own lane in which the subject vehicle M runs is a lane adjacent to a road shoulder on the basis of a result of the recognition performed using the recognizer 130 (Step S201). In a case in which its own lane in which the subject vehicle M runs is a lane adjacent to the road shoulder, the offset direction determiner 145 determines a side close to the road shoulder as the offset direction Do (Step S202). For example, the subject vehicle M, as illustrated in FIG. 9, moves to a side close to a road shoulder SD (in other words, a further left side than the center line Lc of its own lane) (point A1), runs at the moved position for a predetermined period (section A2), and then returns to the original position (point A3). Accordingly, the subject vehicle M moves to a side on which any other vehicle is not present, and accordingly, it can be suppressed that a vehicle occupant is frightened by the presence of another vehicle.

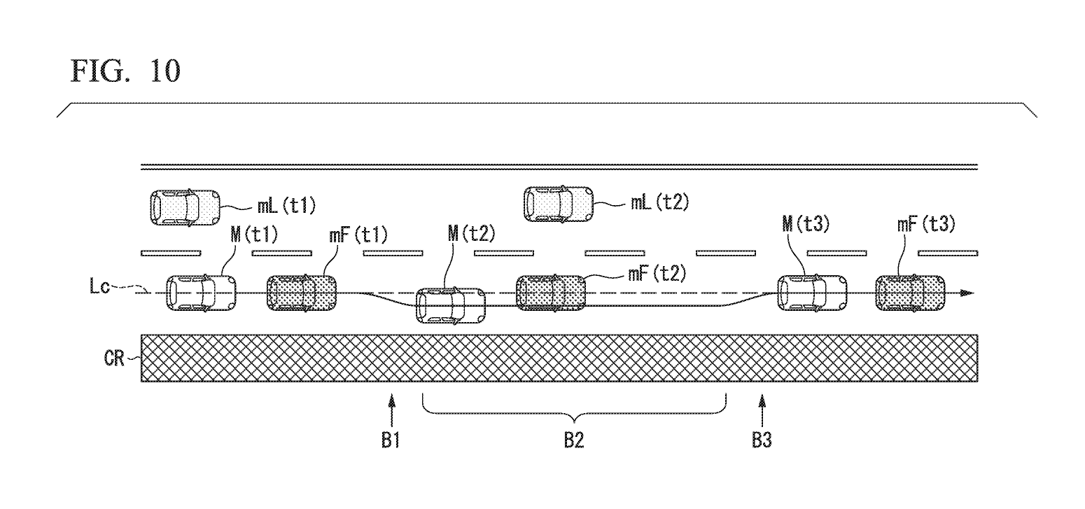

On the other hand, in a case in which its own lane in which the subject vehicle M runs is not a lane adjacent to the road shoulder in Step S201, the offset direction determiner 145 determines whether or not its own lane in which the subject vehicle M runs is a lane adjacent to a median strip on the basis of a result of the recognition performed using the recognizer 130 (Step S203). In a case in which its own lane in which the subject vehicle M runs is a lane adjacent to the median strip, the offset direction determiner 145 determines a side close to the median strip as the offset direction Do (Step S204). For example, the subject vehicle M, as illustrated in FIG. 10, moves to a side close to the median strip CR (in other words, a further right side than the center line Lc of its own lane) (point B1), runs for a predetermined period at the moved position (section B2), and then returns to the original position (point B3). In such a case, the subject vehicle M moves to a side on which another car is not present, and accordingly, it can be suppressed that a vehicle occupant is frightened by the presence of another vehicle.

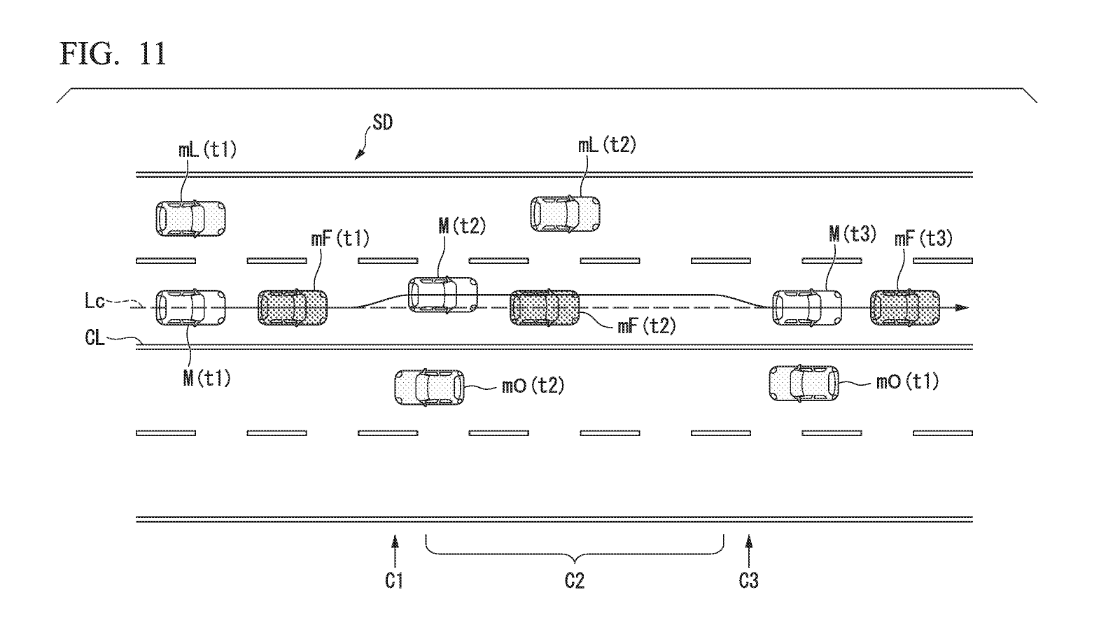

On the other hand, in a case in which its own lane in which the subject vehicle M runs is not a lane adjacent to the median strip in Step S203, the offset direction determiner 145 determines whether or not its own lane in which the subject vehicle M runs is a lane adjacent to a center line on the basis of a result of the recognition performed using the recognizer 130 (Step S205). The center line is a road partition line that partitions lanes having different advancement directions and does not include a structure having a height of some degree or more. For example, a low structure such as a cat's-eye and a bot's dot may be included in the center line. In a case in which its own lane in which the subject vehicle M runs is a lane adjacent to the center line in Step S205, the offset direction determiner 145 determines a side far from the center line as the offset direction Do (Step S206). For example, the subject vehicle M, as illustrated in FIG. 11, moves to a side far from the center line CL (in other words, a further left side than the center line Lc of its own lane) from the center line CL (point C1), runs at the moved position for a predetermined period (section C2), and then returns to the original position (point C3). In such a case, the subject vehicle M moves to a side far from the opposing lane, and accordingly, it can be suppressed that a vehicle occupant is frightened by the presence of an oncoming vehicle.

On the other hand, in a case in which its own lane in which the subject vehicle M runs is not a lane adjacent to the center line in Step S205, the offset direction determiner 145 determines whether or not other vehicles are detected from both lanes adjacent to its own lane in which the subject vehicle M runs on the basis of a result of the recognition performed using the recognizer 130 (Step S211). In a case in which other vehicles are not detected from both lanes adjacent to its own lane in which the subject vehicle M runs, the offset direction determiner 145 determines an adjacent lane side in which no other vehicle is detected as the offset direction Do (Step S212). In such a case, since the subject vehicle M moves to the side on which no other vehicle is present, it can be suppressed that a vehicle occupant is frightened by the presence of another vehicle. In a case in which no other cars are detected from both the adjacent lanes, the offset direction Do may be set as any one thereof.

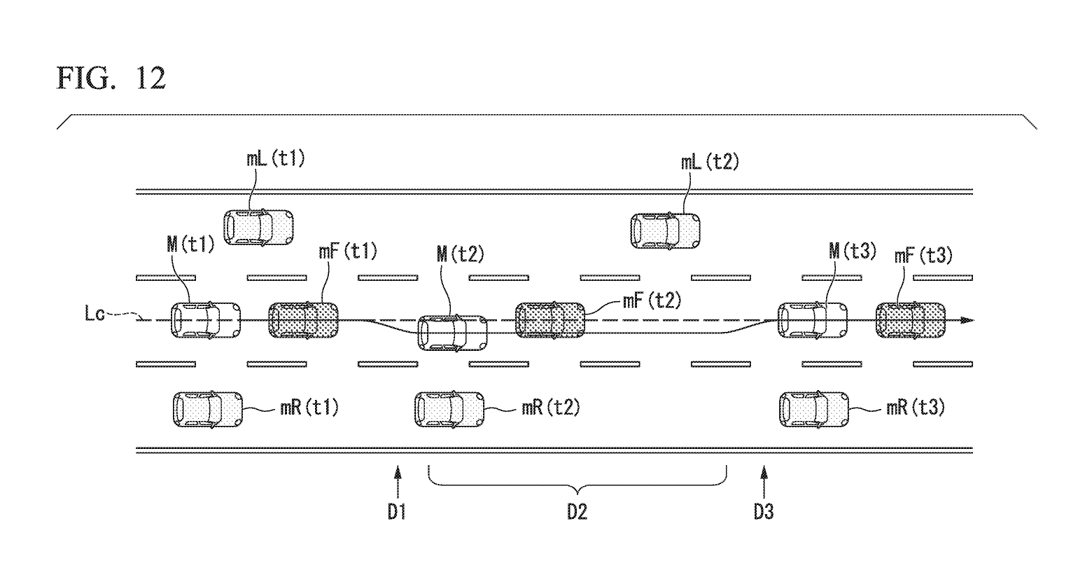

On the other hand, in a case in which other vehicles are detected from both adjacent lines of its own lane in which the subject vehicle M runs in Step S211, the offset direction determiner 145 compares the speeds of the other vehicles running in the adjacent lanes with the speed of the subject vehicle M on the basis of a result of the recognition performed using the object recognizing device 16, a result of the detection performed using the vehicle sensor 40, and the like and determines an adjacent lane in which the other vehicle, of which the speed is close to the speed of the subject vehicle M, runs (Step S213). For example, the offset direction determiner 145 derives differences between the speeds of the other vehicles running in the adjacent lanes (a speed of another vehicle or an average speed of a plurality of other vehicles) and the speed of the subject vehicle M. Then, the offset direction determiner 145 determines that the speed of a vehicle running in an adjacent lane having a small difference that has been derived is close to the speed of the subject vehicle M. As illustrated in FIG. 12, a case in which the subject vehicle M runs in the center lane among three lanes corresponds to this case. In a case in which it is determined that the speed of another vehicle mL running on a left adjacent lane is closer to the speed of the subject vehicle M than another vehicle mR running in a right adjacent lane, the offset direction determiner 145 determines the left side as the offset direction Do (Step S214). On the other hand, in a case in which it is determined that the speed of another vehicle mR is closer to the speed of the subject vehicle M than another vehicle mL, the offset direction determiner 145 determines the right side as the offset direction Do (Step S215). In such a case, since the subject vehicle M approaches an adjacent lane of a side in which a vehicle has a lower relative speed with respect to the subject vehicle M, it can be suppressed that a vehicle occupant is frightened by the presence of another vehicle. FIG. 12 illustrates an example of a case in which the process of Step S215 is executed. The subject vehicle M moves to a further right side than the center line Lc of its own lane (point D1), runs at the moved position for a predetermined period (section D2), and returns to the original position (point D3).

### [Offset Direction Determining Process (2)]

A part of the offset direction determining process (1) described above may be the following process. The offset direction determiner 145 determines whether or not another vehicle is detected in a left adjacent lane of its own lane of the subject vehicle M on the basis of a result of the recognition performed using the recognizer 130 (Step S207). In a case in which another vehicle is not detected from the left adjacent lane, the offset direction determiner 145 determines the left side as the offset direction Do (Step S208). In such a case, the subject vehicle M moves to the side on which another vehicle is not present, and accordingly, it can be suppressed that a vehicle occupant is frightened by the presence of another vehicle. In a region in which vehicles run with keeping to the right side, the offset direction determiner 145 determines whether or not another vehicle is detected from the right adjacent lane in Step S207. Then, in a case in which another vehicle is not detected from the right adjacent lane, the offset direction determiner 145 determines the right side as the offset direction Do.

In a case in which another vehicle is detected in the left adjacent lane of its own lane of the subject vehicle M in Step S207, the offset direction determiner 145 determines whether or not another vehicle is detected in the right adjacent lane of its own land of the subject vehicle M on the basis of a result of the recognition performed using the recognizer 130 (Step S209). In a case in which another vehicle is not detected from the right adjacent lane, the offset direction determiner 145 determines the right side as the offset direction Do (Step S210). In such a case, the subject vehicle M moves to a side on which another vehicle is not present, and accordingly, it can be suppressed that a vehicle occupant is frightened by the presence of another vehicle. In a region in which vehicles run with keeping to the right side, the offset direction determiner 145 determines whether or not another vehicle is detected from the left adjacent lane in Step S209. Then, in a case in which another vehicle is not detected from the left adjacent lane, the offset direction determiner 145 determines the left side as the offset direction Do. Thereafter, the offset direction determiner 145 executes Steps S213 to S215 described above.

### [Offset Direction Determining Process (3)]

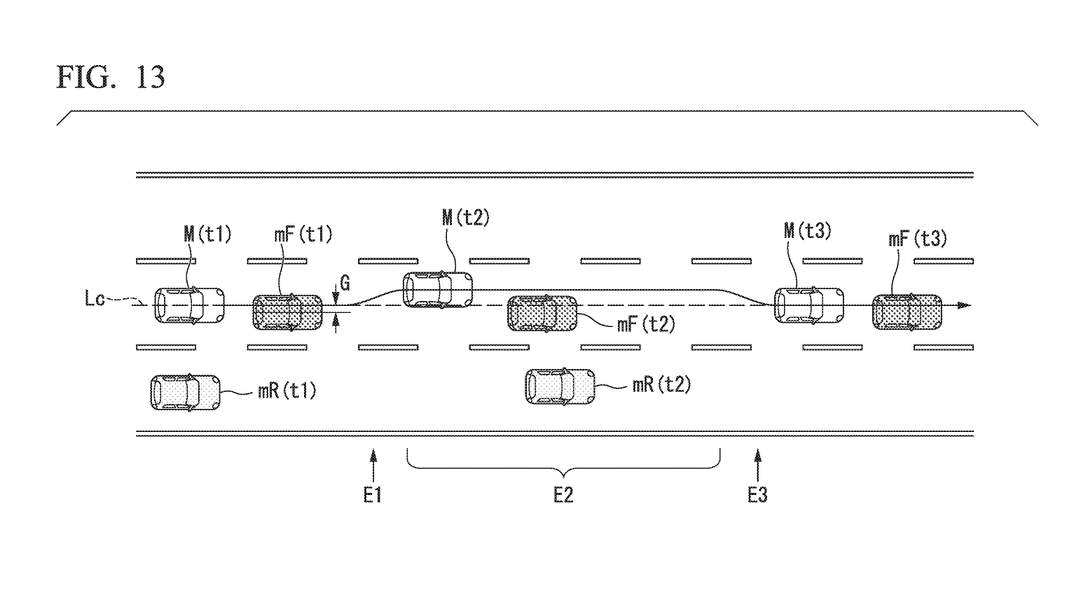

Here, a process executed in a case in which a running position of a vehicle running ahead or a vehicle running behind deviates from the center of its own lane will be described. The offset direction determiner 145 determines whether or not a running position of a vehicle running ahead or a vehicle running behind deviates from the center of the lane on the basis of a result of the recognition performed using the recognizer 130 (Step S221). For example, the offset direction determiner 145 derives a deviation quantity G between the center of the vehicle mF running ahead in front of the subject vehicle M and the center line Lc of its own lane on the basis of a result of the recognition performed using the recognizer 130. Then, in a case in which the derived deviation quantity G is equal to or greater than a threshold, the offset direction determiner 145 determines that the running position of the vehicle mF running ahead deviates from the center of the lane. FIG. 13 illustrates an example of a case in which a deviation quantity G of the vehicle mF running ahead is equal to or more than the threshold. In this case, the offset direction determiner 145 determines that the running position of the vehicle mF running ahead deviates from the center of the lane to the right side. In Step S221, in a case in which there is no deviation of the running position of the vehicle running ahead or the vehicle running behind in Step S221, the offset direction determiner 145 ends this process.

In a case in which the running position of the vehicle running ahead or the vehicle running behind deviates from the center of the lane in Step S221, the offset direction determiner 145 determines whether or not another vehicle is detected from an adjacent vehicle disposed on a side opposite to the side in which the vehicle running ahead or the vehicle running behind deviates from the center of the lane on the basis of a result of the recognition performed using the recognizer 130 (Step S222). In a case in which another vehicle is not detected from the adjacent lane in Step S222, the offset direction determiner 145 determines a side opposite to the side on which the vehicle running ahead or the vehicle running behind deviates from the center of the lane as the offset direction Do (Step S223). For example, as illustrated in FIG. 13, in a case in which no other vehicle is detected from the adjacent lane disposed on a side (left side) opposite to the side (right side) on which the vehicle running ahead or the vehicle running behind deviates from the center of the lane, the offset direction determiner 145 determines the left side as the offset direction Do. Then, the subject vehicle M, as illustrated in FIG. 13, moves to the side opposite to the side on which the vehicle running ahead or the vehicle running behind deviates from the center of the lane, in other words, a further left side than the center line Lc of its own lane (point E1), runs at the moved position for a predetermined period (section E2), and returns to the original position (point E3). In such a case, also in a case in which the subject vehicle M moves to the side opposite to the side on which the vehicle running ahead or the vehicle running behind deviates from the center, the subject vehicle M moves to the adjacent lane side on which no other vehicle is present, and accordingly, it can be suppressed that a vehicle occupant is frightened by the presence of another vehicle.

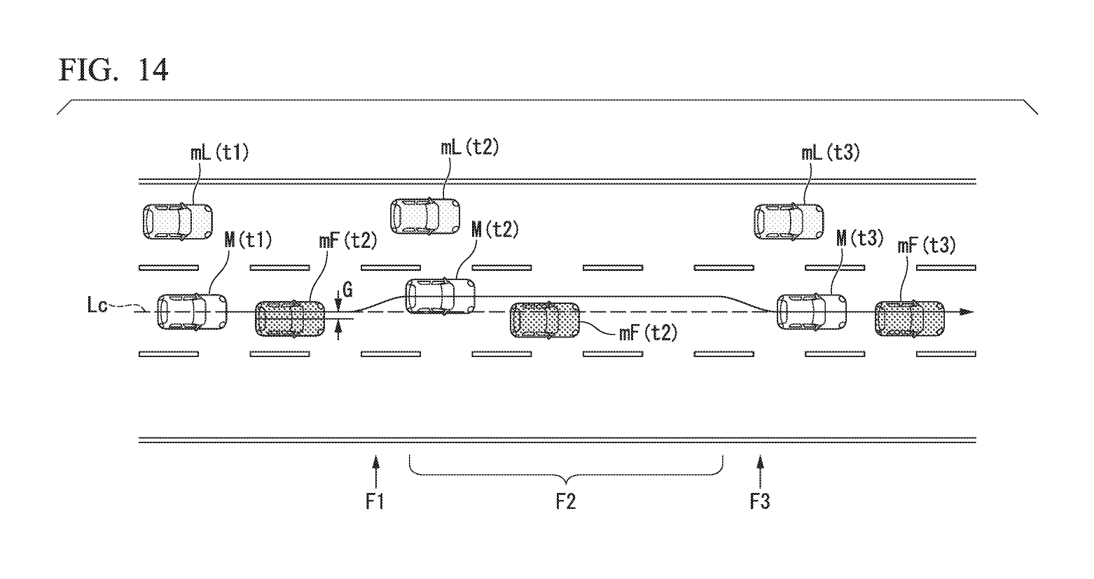

On the other hand, in a case in which another vehicle is detected from the adjacent lane disposed on the side opposite to the side on which the vehicle running ahead or the vehicle running behind deviates from the center of the lane in Step S222, the offset direction determiner 145 acquires the speed of the another vehicle running in the adjacent lane disposed on the side opposite to the side on which the vehicle running ahead or the vehicle running behind deviates from the center of the lane on the basis of a result of the recognition performed using the object recognizing device 16, a result of the detection performed using the vehicle sensor 40, and the like and determines whether or not the acquired speed of the another speed is close to the speed of the subject vehicle (Step S224). In Step S224, in a case in which the speed of the another vehicle is close to the speed of the subject vehicle, the offset direction determiner 145 determines the side opposite to the side on which the vehicle running ahead or the vehicle running behind deviates from the center of the lane as the offset direction Do (Step S223). For example, in the example illustrated in FIG. 14, a difference between another vehicle mL running in the adjacent lane disposed on the side opposite to the side on which the vehicle running ahead or the vehicle running behind deviates from the center of the lane and the speed of the subject vehicle M is equal to or less than a threshold. In this case, the offset direction determiner 145 determines the left side as the offset direction Do. Then, the subject vehicle M, as illustrated in FIG. 14, moves to the side (a further left side than the center line Lc of its own lane) opposite to the side on which the vehicle running ahead or the vehicle running behind deviates from the center of the lane (point F1), runs at the moved position for a predetermined period (section F2) and returns to the original position (point F3). In such a case, also in a case in which the subject vehicle M moves to a side opposite to the side on which the vehicle running ahead or the vehicle running behind deviates from the center of the lane, the subject vehicle approaches an adjacent lane on a side on which a relative speed of a vehicle is low with respect to the subject vehicle M, and accordingly, it can be suppressed that a vehicle occupant is frightened by the presence of another vehicle.

On the other hand, in a case in which the speed of another vehicle is not close to the speed of the subject vehicle in Step S224, the offset direction determiner 145 determines whether or not the speed of another vehicle running in the adjacent lane disposed on the side opposite to the side on which the vehicle running ahead or the vehicle running behind deviates from the center of the lane is lower than the speed of the subject vehicle on the basis of a result of the recognition performed using the object recognizing device 16, a result of the detection performed using the vehicle sensor 40, and the like (step S225). In a case in which the speed of the another vehicle is lower than the speed of the subject vehicle in Step S225, the offset direction determiner 145 determines the side opposite to the side on which the vehicle running ahead or the vehicle running behind deviates from the center of the lane as the offset direction Do (Step S223). For example, in a case in which a difference between the speed of the another vehicle mL illustrated in FIG. 14 and the speed of the subject vehicle M is more than the threshold, and the speed of the subject vehicle M is higher than the speed of the another vehicle mL, the offset direction determiner 145 determines the left side as the offset direction Do. Then, the subject vehicle M, as illustrated in FIG. 14, moves to the side opposite to the side on which there is a deviation (in other words, a further left side than the center line Lc of its own lane) (point F1), runs at the moved position for a predetermined period (section F2), and then returns to the original position (point F3). In such a case, also in a case in which the subject vehicle M moves to a side opposite to the side on which the vehicle running ahead or the vehicle running behind deviates from the center of the lane, the subject vehicle approaches an adjacent lane on a side on which the speed of the vehicle is lower than the subject vehicle M, and accordingly, it can be suppressed that a vehicle occupant is frightened by the presence of another vehicle.

On the other hand, in a case in which the speed of the another vehicle is not lower (higher) than the speed of the subject vehicle in Step S225, the offset direction determiner 145 determines whether or not another vehicle m running in an adjacent lane disposed on a side opposite to the side on which the vehicle running ahead or the vehicle running behind deviates from the center of the lane has overtaken the subject vehicle M on the basis of a result of the recognition performed using the recognizer 130 (Step S226). In a case in which the another vehicle m has not overtaken the subject vehicle M in Step S226, the offset direction determiner 145 returns the process to Step S226 and repeats the process until “Yes” is determined. On the other hand, in a case in which the another vehicle m has overtaken the subject vehicle M in Step S226, the offset direction determiner 145 determines the side opposite to the side on which the vehicle running ahead or the vehicle running behind deviates from the center of the lane as the offset direction Do (Step S223). For example, in a case in which a difference between the speed of the another vehicle mL illustrated in FIG. 14 and the speed of the subject vehicle M is larger than the threshold, and the speed of the another vehicle mL is higher than the speed of the subject vehicle M, the offset direction determiner 145 sets the left side as the offset direction Do after the another vehicle mL overtakes the subject vehicle M. In such a case, also in a case in which the subject vehicle M moves to the side opposite to the side on which the vehicle running ahead or the vehicle running behind deviates from the center of the lane, the subject vehicle moves to the side on which no other vehicle is present, and accordingly, it can be suppressed that a vehicle occupant is frightened by the presence of another vehicle.

In such a case, in a case in which the running position of the vehicle running ahead or the vehicle running behind deviates from the center of the lane, the subject vehicle M can be shifted to the side opposite to the side on which the deviation has occurred, and accordingly, the recognition rate of road partition lines can be improved. In a case in which another vehicle runs in an adjacent lane disposed on the shift side, and the another vehicle overtakes the subject vehicle at a speed higher than that of the subject vehicle M, the subject vehicle can be shifted after the another vehicle passes. Accordingly, a situation in which the subject vehicle approaches another vehicle running at a high speed in the adjacent lane can be avoided.

The offset direction determiner 145 may execute the process of the offset direction determining process (3) with a higher priority than the offset direction determining process (1) or (2). In such a case, for example, in a case in which “No” is determined in Step S221, the offset direction determiner 145 executes the offset direction determining process (1) or (2).

The vehicle control device according to the first embodiment described above includes the camera 10 that images a side in front or side to the rear of the vehicle, the road partition line recognizer 131 that recognizes the position of a road partition line on the basis of an image captured by the camera 10, and the second controller 160 that controls at least steering of the subject vehicle M on the basis of the position of the road partition line recognized by the road partition line recognizer 131. In a case in which the degree of recognition of road partition lines acquired by the road partition line recognizer 131 decreases due to the presence of a car running ahead or a car running behind, the second controller 160 causes the subject vehicle M to run while deviating from the center of the lane. Accordingly, the subject vehicle M is allowed to be able to run at a position at which the camera 10 can easily image the road partition line, therefore, the road partition line can be recognized.

### Second Embodiment

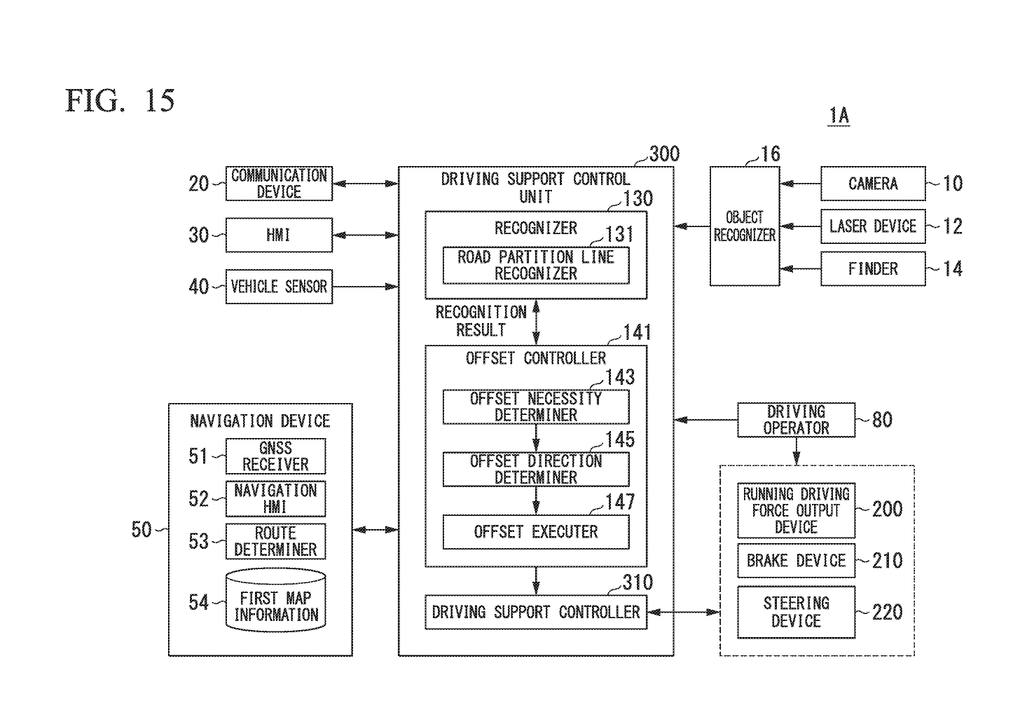

Hereinafter, an example in which a vehicle system 1A having a function and a configuration similar to those of a part of the vehicle system 1 described above is used in vehicle having a driving support function will be described with reference to FIG. 15. In description of the vehicle system 1A, a function and a configuration similar to those of a part of the vehicle system 1 will not be described.

FIG. 15 is a configuration diagram of the vehicle system 1A using the vehicle control device according to an embodiment in a vehicle having a driving support function. The same name will be assigned to a function or a component similar to that of the vehicle system 1, and description thereof will not be presented. The vehicle system 1A, for example, includes a driving support controller 300 replacing a part of the vehicle system 1. The driving support controller 300 includes a recognizer 130, an offset controller 141, and a driving support controller 310. The configuration illustrated in FIG. 15 is merely one example, and a part of the configuration may be omitted, and another component may be added thereto.

The driving support controller 310, for example, has functions of a lane keeping assist system (LKAS), an adaptive cruise control system (ACC), an auto lane change system (ALC), and the like.

An offset executer 147 sets a position shifted by an offset quantity Yo in an offset direction Do determined by an offset direction determiner 145 as a running position for the LKAS function. In accordance with this setting, the driving support controller 310 causes a subject vehicle M to run while deviating from the center of its own lane to the right side or the left side. Then, in a case in which it is determined that an offset time To has elapsed, the offset executer 147 sets the center of its lane as the running position for the LKAS function. In accordance with the setting, the driving support controller 310 causes the subject vehicle M to run at the center of its own lane.

According to the vehicle control device of the second embodiment described above, effects similar to those according to the first embodiment can be acquired.

### <Hardware Configuration>

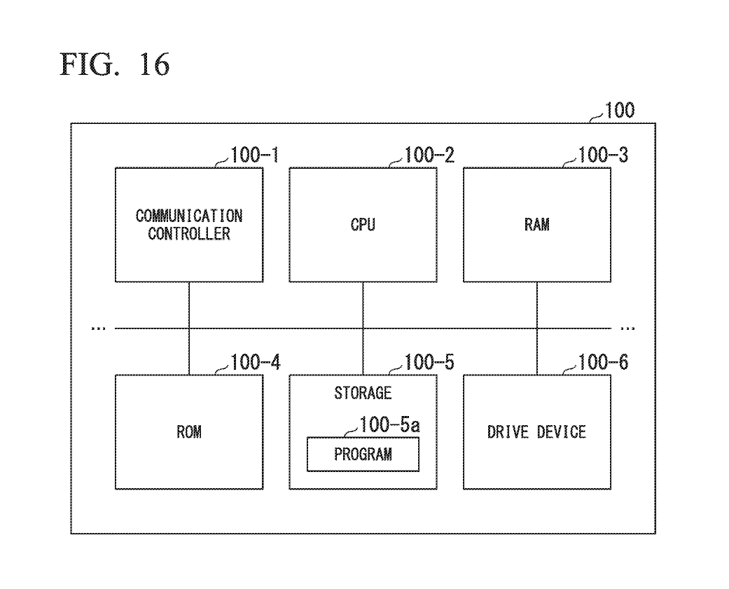

The vehicle control device according to the embodiment described above, for example, is realized by a hardware configuration as illustrated in FIG. 16. FIG. 16 is a diagram illustrating one example of the hardware configuration of the vehicle control device according to an embodiment.

The vehicle control device has a configuration in which a communication controller 100-1, a CPU 100-2, a RAM 100-3, a ROM 100-4, a secondary storage 100-5 such as a flash memory or an HDD, and a drive device 100-6 are interconnected through an internal bus or dedicated communication lines. A portable storage medium such as an optical disc is loaded into the drive device 100-6. A program 100-5a stored in the secondary storage 100-5 is expanded in the RAM 100-4 by a DMA controller (not illustrated) or the like and is executed by the CPU 100-3, whereby the vehicle control device is realized. The program referred to by the CPU 100-2 may be stored in a portable storage medium loaded into the drive device 100-6 or may be downloaded from another device through a network NW.

The embodiment can be represented as below.

A vehicle control device includes an imager imaging a side in front or side to the rear of a vehicle, a storage device, and a hardware processor executing a program stored in the storage device.

The vehicle control device is configured such that, by executing the program described above using the hardware processor, the road partition line recognizer recognizes the position of a road partition line on the basis of an image captured by the imager, the driving controller controls at least steering of the vehicle on the basis of the position of the road partition line recognized by the road partition line recognizer, and, in a case in which a degree of recognition of the road partition line using the road partition line recognizer decreases due to presence of a vehicle running ahead or a vehicle running behind, the driving controller causes the vehicle to run while deviating from center of the lane.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
an imager imaging a side in front or side to the rear of a vehicle;
a road partition line recognizer recognizing a position of a road partition line on the basis of an image captured by the imager; and
a driving controller controlling at least steering of the vehicle on the basis of the position of the road partition line recognized by the road partition line recognizer,
wherein, in a case in which a degree of recognition of the road partition line using the road partition line recognizer decreases due to presence of a vehicle running ahead or a vehicle running behind, the driving controller causes the vehicle to run while deviating from a center of a lane.

2. The vehicle control device according to claim 1, further comprising a speed acquirer acquiring a speed of another vehicle running in an adjacent lane,
wherein the driving controller determines a side to which the vehicle deviates in running from the center of the lane on the basis of the speed of the another vehicle acquired by the speed acquirer.

3. The vehicle control device according to claim 2, wherein the driving controller causes the vehicle to run while deviating from the center of the lane such that the vehicle is close to a side of an adjacent lane in which the speed of the another vehicle acquired by the speed acquirer is close to the speed of the vehicle.

4. The vehicle control device according to claim 1, wherein the driving controller causes the vehicle to run while deviating from the center of the lane for a predetermined time and then run along the center of the lane.

5. The vehicle control device according to claim 1, wherein, in a case in which a vehicle running ahead or a vehicle running behind runs while deviating to one side from the center of the lane, the driving controller causes the vehicle to run while deviating from the center of the lane on a side opposite to a side on which the vehicle running ahead or the vehicle running behind deviates from the center of the lane.

6. The vehicle control device according to claim 1, wherein, in a case in which there is a curve in an advancement direction of the vehicle, the driving controller causes the vehicle to run while deviating from the center of the lane.

7. A vehicle control method using an in-vehicle computer, comprising:
imaging a side in front or side to the rear of a vehicle using an imager;
recognizing a position of a road partition line on the basis of an image captured by the imager using a road partition line recognizer;
controlling at least steering of the vehicle on the basis of the position of the road partition line recognized by the road partition line recognizer using a driving controller; and
causing the vehicle to run while deviating from a center of a lane using the driving controller in a case in which a degree of recognition of the road partition line using the road partition line recognizer decreases due to presence of a vehicle running ahead or a vehicle running behind.

8. A non-transitory computer-readable storage medium storing thereon a program for causing a computer mounted in a vehicle including an imager imaging a side in front or side to the rear of the vehicle to execute:
a process of recognizing a position of a road partition line on the basis of an image captured by the imager;
a process of controlling at least steering of the vehicle on the basis of the recognized position of the road partition line; and
a process of causing the vehicle to run while deviating from a center of a lane in a case in which a degree of recognition of the road partition line decreases due to presence of a vehicle running ahead or a vehicle running behind.
